(19) United States
(12) Patent Application Publication
(10) Pub. No.: US 2006/0151259 A1
(43) Pub. Date: Jul. 13, 2006

(54) Locking/release device

(76) Inventors: Ivan Tomasi, Sovizzo (IT); Roberto Gorza, Feltre (IT)

Correspondence Address: MODIANO & ASSOCIATE, VIA MERAVIGLI I6, MILAN, 20123, IT

(21) Appl. No.: 10/544,370

(22) PCT Filed: Dec. 22, 2003
(86) PCT No.: PCT/EP03/14711

§ 371 Date: Aug. 3, 2005

(30) Foreign Application Priority Data
Feb. 7, 2003 (IT) VR2003U000004

(51) Int. Cl. B60T 1/00

(52) U.S. Cl. 188/31; 188/19; 280/647

(57) ABSTRACT

A locking/release device particularly for pushchairs, prams or the like, comprising an actuation lever system supporting an engagement device and articulated to a supporting structure movable with respect to a locking element, having one abutment region and at least one engagement seat; the actuation lever system is mounted rotatable about a pivoting axis to pass from a release position, to a locking position of the locking element; in an abutment position, the engagement device abuts against at least one portion of the abutment region. An elastic loading element of the device acts between a first coupling portion of the supporting structure and the actuation lever system.

### TECHNICAL FIELD

The present invention relates to a locking/release device particularly suitable for pushchairs and prams for young children.

### BACKGROUND ART

During normal use of pushchairs and prams it is necessary to allow the user (by using locking/release devices constituted for example by actuation lever systems) to simply and effectively lock devices supported by the wheels, such as for example braking devices or castering devices (i.e., capable of ensuring or preventing castering motion of the wheel or set of wheels in the case of twin wheels).

Currently, devices used to lock rotation of the wheels about their own axis (braking devices) or used to prevent castering motion are generally constituted by an actuation lever that is normally pivoted to a supporting structure of the wheel or set of wheels, which supports an engagement pin that is designed to engage, if the user acts on such lever, within a seat formed on a ring that is rigidly coupled to the wheel rotation axis in the case of braking devices, or in a castering locking seat in the case of castering devices.

Although currently commercially available locking/release devices are presently widely used, they are not devoid of drawbacks.

The user, by acting on the lever to lock the device, in fact often fails to make the pin engage directly in the respective seat but makes it abut against the peripheral profile of the ring (in the case of a braking device) or of the upper edge of the support, in the case of a device for locking the castering motion.

At this point the user is in a condition in which he has to take the pressure off the lever in order to turn the wheel about its own axis or about the castering axis and try, by pressing the lever again, to insert the engagement pin within the respective seat.

It is evident that actuation of the devices described above is very awkward and laborious.

### DISCLOSURE OF THE INVENTION

The aim of the present invention is to provide a locking/release device that is capable of eliminating or at least reducing significantly the drawback suffered by known devices.

Within this aim, an object of the invention is to provide a locking/release device that has a low production cost so as to be advantageous also from the economical standpoint.

This aim and this and other objects that will become better apparent hereinafter are achieved by a locking/release device according to the invention, particularly for pushchairs, prams or the like, comprising an actuation lever system that supports engagement means and is articulated to a supporting structure that can move with respect to at least one locking element, which has at least one abutment region and at least one engagement seat for the engagement means, the actuation lever system being mounted rotatable about a pivoting axis in order to pass from a release position, in which the engagement means are disengaged from the abutment portion, to a locking position of the locking element, in which the engagement means engage said at least one engagement seat, at least one abutment position being further provided in which the engagement means abut against at least one portion of said at least one abutment region, characterized in that it comprises elastic loading means that act between a first coupling portion that is supported by said supporting structure and the actuation lever system and are adapted to generate a thrust that acts along an axis of action that can rotate about said coupling portion, said action axis intersecting said pivoting axis in an intermediate position between the abutment position and the release position.

Advantageously, a locking/release device according to the invention has, in the abutment position, between the action axis and the pivoting axis, an arm that is adapted to generate a torque for pushing the engagement means against said at least one portion of said at least one abutment region.

Conveniently, in a locking/release device according to the invention the elastic loading means comprise a torsion spring that is coupled to the actuation lever system at a second coupling portion.

### BRIEF DESCRIPTION OF THE DRAWINGS

Further features and advantages of the present invention will become better apparent from the following detailed description of some currently preferred examples of embodiments, given merely by way of non-limiting example with reference to the accompanying drawings, wherein:

FIG. 1 is a side elevation view of a locking/release device according to the invention, associated with a braking ring with the lever system in the release position;

FIG. 2 is a side view, similar to FIG. 1, in which the lever system is in the abutment position;

FIG. 3 is a side view, similar to FIGS. 1 and 2, in which the lever system is in the locking position;

FIG. 4 is a sectional elevation view of a locking/release device associated with a castering device in which the lever system is in the release position;

FIG. 5 is a view, similar to FIG. 4, in which the lever system is in the abutment position;

FIG. 6 is a view, similar to FIGS. 4 and 5, in which the lever system is in the locking position; and

FIG. 7 is a perspective view of a trap spring according to the invention.

### WAYS OF CARRYING OUT THE INVENTION

In the examples of embodiments that follow, individual characteristics, given in relation to specific examples, may actually be interchanged with other different characteristics that exist in other examples of embodiments.

With reference to FIGS. 1 to 3, a locking/release device, generally designated by the reference numeral 1, according to the invention, can be associated with a braking device or brake 2.

Such locking/release device is constituted by an actuation lever system 3 that supports engagement means such as for example a pin 4.

The actuation lever system 3 is articulated to a supporting structure 5, which in turn supports the wheel or wheels, provided with at least one locking element rotationally rigidly coupled thereon; said locking element is accordingly movable with respect to the supporting structure 5.

In the example shown in FIGS. 1-3, the locking element is constituted by a braking ring 6.

The braking ring 6 (and more generally the locking element) has at least one abutment region 7 (constituted in the illustrated example by the teeth of the braking ring 6) and at least one engagement seat 8 (constituted in this case by the gaps formed between two successive teeth).

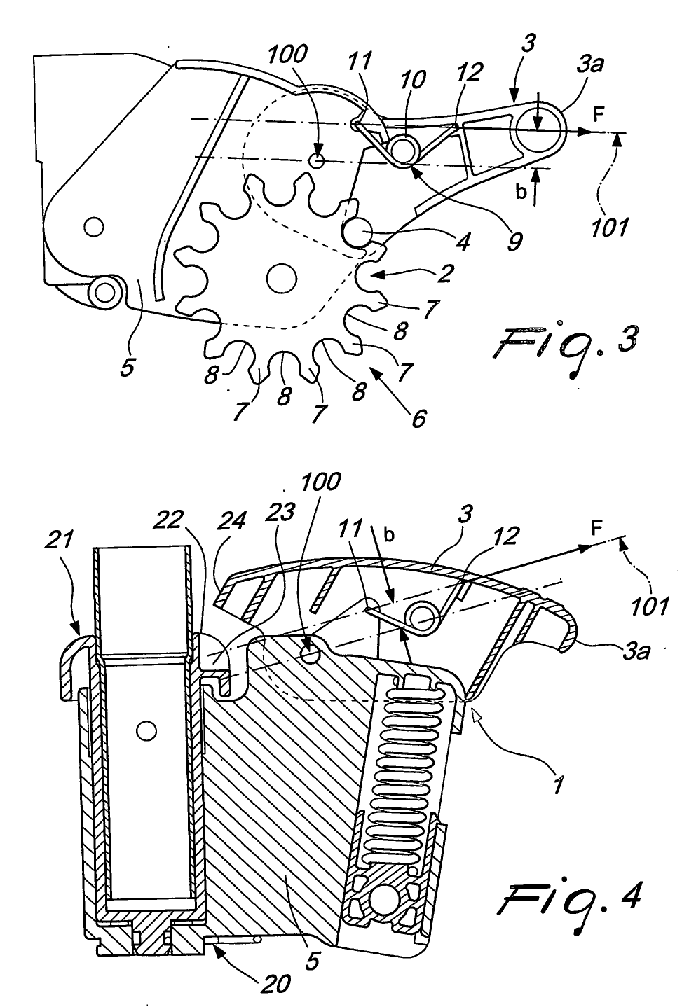

The actuation lever system 3 is mounted rotatable about a pivoting axis 100 and is adapted to pass, under actuation by the user, from a release position (shown in FIG. 1), in which the pin 4 is disengaged from the engagement seat or seats 8, to a position for locking the locking element, which is constituted in this case by the braking ring 6 (shown in FIG. 3) and in which the pin 4 is accommodated within at least one of the engagement seats 8 provided in said locking element.

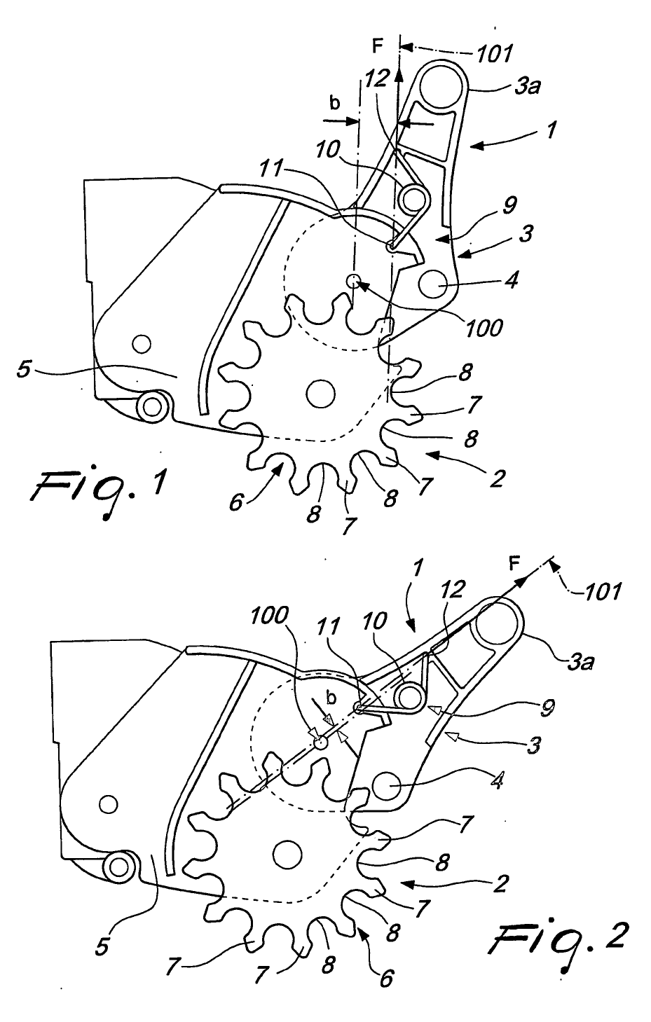

In particular, the lever system 3 may also assume an abutment position (shown in FIG. 2), in which the pin 4 (or more generally the engagement means) abuts against at least one portion of at least one of the abutment regions 7.

According to the invention, elastic loading means 9, such as for example a trap spring 10, as shown in the figures, act between the supporting structure 5 and the actuation lever system 3.

In particular, the trap spring 10 is coupled, at a first substantially end portion thereof, to a first coupling portion 11 that is supported by the supporting structure 5 and, at the other opposite substantially end portion, to a second coupling or, equivalently, abutment portion 12 that is supported by the actuation lever system 3.

It is evident that the trap spring 10 (and equivalently other elastic loading means), if loaded (for example by moving the substantially end portions mutually closer) applies a force, designated by the letter F, to the actuation lever system 3, which acts along a thrust axis 101 formed by the straight line that passes through the first coupling portion 11 and through the second coupling or abutment portion 12.

As shown by the figures, the thrust axis 101 rotates about the first coupling portion 11 as a consequence of the rotation of the actuation lever system 3 about a pivoting axis 100.

The force F therefore generates a torque for the rotation of the actuation lever system 3 with respect to the pivoting axis 100 depending on an arm (b) that is generated between the thrust axis 101 and the pivoting axis 100.

It is evident, with particular reference to FIGS. 2 and 3, that the arrangement of the pivoting axis 100 and of the thrust axis 101 is such that when the actuation lever system 3 is in the release position such arrangement generates a torque that tends to keep the lever system 3 in said position (in the drawing, the torque generated in this position has a “counterclockwise” direction), while when the actuation lever system 3 is in the locking position, the generated torque tends to keep the pin 4 within the seat 8 (and therefore the torque generated in this position has a “clockwise” direction).

According to the invention, the arrangement is such that in the abutment position (see FIG. 2), the torque generated by the force F tends to press the pin 4 against the abutment region 7, accordingly keeping the pin 4 pressed against the abutment region 7 even if the user removes the pressure from the end actuation portion 3a of the actuation lever system 3.

This allows, by turning the wheel with which the braking ring 6 is associated, the immediate transition of the actuation lever system 3 from the abutment position to the locking position without requiring the user to act on the actuation lever system 3 again.

Obviously, in order to allow the torque generated when the lever system 3 is in the abutment condition to make the pin 4 press against the abutment region 7, the balance position determined by the position of the actuation lever system 3 in which the thrust axis 101 intersects the pivoting axis 100 must be intermediate between the abutment position and the release position; in a fully equivalent manner, one can say that the abutment position must be intermediate between the balance position and the locking position.

Reverting now to FIGS. 4 to 6, a locking/release device 1 according to the invention can, in a manner that is fully equivalent to what has been described above, be associated with a castering device 20, which comprises a supporting structure 5 and is rotationally coupled to a supporting bush 21 (which in this application forms the locking element at its edge that is arranged upward during use).

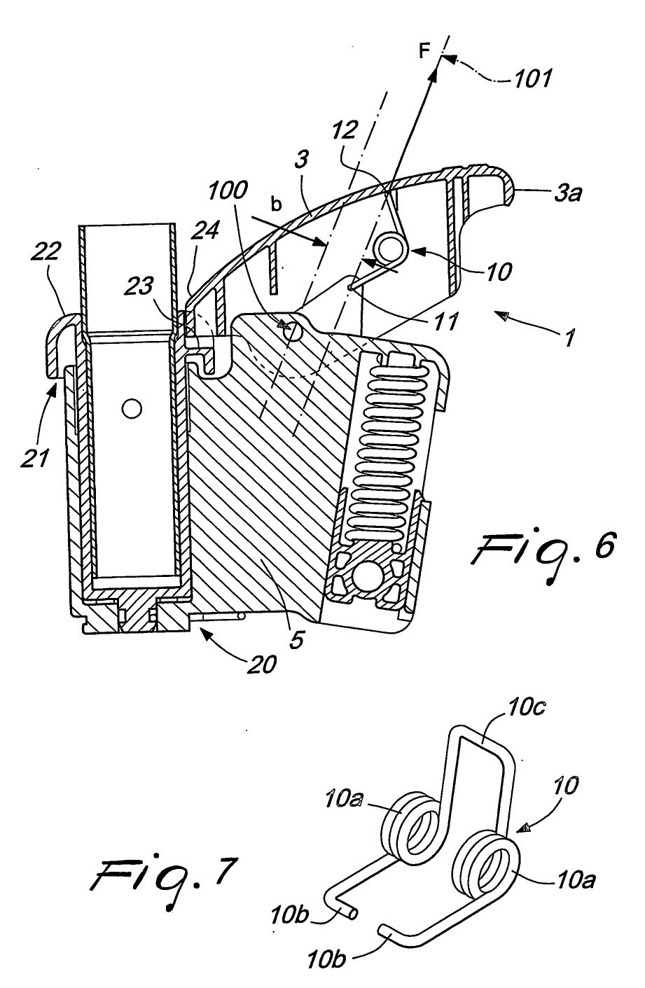

Therefore, at the edge of the supporting bush 21 that is arranged upward during use there is an abutment region 22 and there is a seat 23, in this case for locking the castering motion, in which, in the locking position (shown in FIG. 6), the engagement means are accommodated; in this case, such means can be constituted by a tab 24 for engaging the actuation lever system 3.

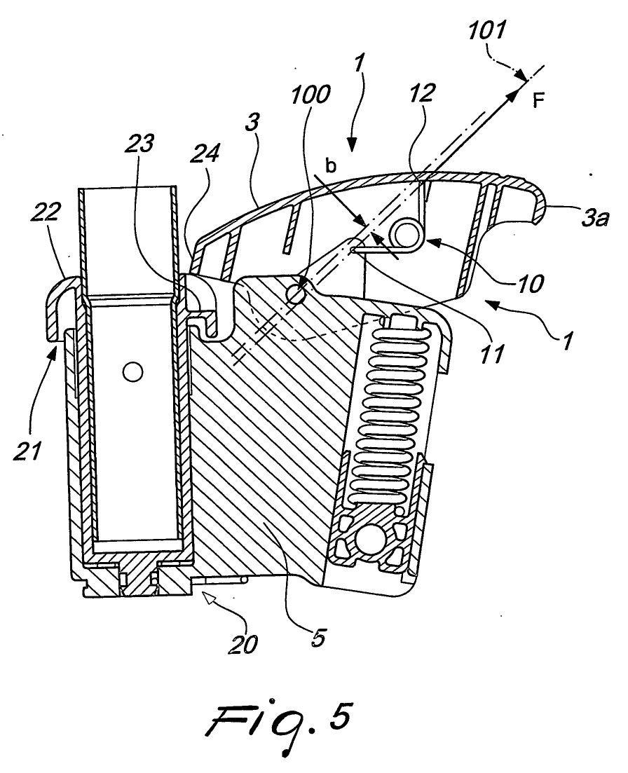

In this different case also, the pivoting axis 100 and the thrust axis 101 must be arranged so that the balance position (in which the thrust axis 101 and the pivoting axis 100 intersect) is intermediate between the abutment position (in this variation shown in FIG. 5) and the release position (FIG. 4); accordingly, in this case also, the abutment position must be intermediate between the balance position and the locking position.

As clearly shown in FIG. 7, the trap spring 10 is constituted by two spiral coils 10a, from which a first thrust arm and a second thrust arm extend respectively, such arms having, substantially at their free ends, a respective coupling element 10b that is adapted to enter the first coupling portion 11 supported by the supporting structure 5.

Furthermore a second arm protrudes from each of the two spiral coils 10a: an abutment element 10c is provided between the end portions of the second arms, and in addition to connecting the two second arms it is adapted to abut, during use, against the second engagement or abutment portion 12 supported by the actuation lever system 3.

It has been shown that a locking/release device for pushchairs, prams or the like, according to the invention, fully achieves the intended aim and object.

All the details may further be replaced with other technically equivalent elements.

In particular, the elastic loading means can be constituted also by an axial spring that is optionally pre-compressed: in this case, it is convenient to review the arrangement of the pivoting axis 101 and of the first and second coupling portions 11 and 12.

The materials and the dimensions may be any according to requirements.

The disclosures in Italian Utility Model Application No. VR2003U000004 from which this application claims priority are incorporated herein by reference.

What is claimed is:

1-12. (canceled)

13. A locking/release device particularly for pushchairs, prams or the like, comprising an actuation lever system that supports engagement means and is articulated to a supporting structure that is movable with respect to a locking element, which has at least one abutment region and at least one engagement seat, said actuation lever system being mounted rotatable about a pivoting axis in order to pass from a release position, in which said engagement means are disengaged from said abutment portion, to a locking position of said locking element, in which said engagement means engage said at least one engagement seat, at least one abutment position being further provided in which said engagement means abut against at least one portion of said at least one abutment region, further comprising elastic loading means that act between a first coupling portion, which is supported by said supporting structure, and said actuation lever system and are adapted to generate a thrust that acts along an axis of action that can rotate about said coupling portion, said action axis intersecting said pivoting axis in an intermediate position between said abutment position and said release position.

14. The locking/release device according to claim 13, further comprising, in the abutment position, between said action axis and said pivoting axis, an arm that is adapted to generate a torque for pushing said engagement means against said at least one portion of said at least one abutment region.

15. The locking/release device according to claim 13, wherein said elastic loading means comprise a torsion spring that is coupled to said lever system at a second coupling portion, said thrust axis being formed by the straight line that passes between said first coupling portion and said second coupling portion.

16. The locking/release device according to claim 15, wherein said torsion spring comprises a trap spring.

17. The locking/release device according to claim 14, wherein said engagement means comprise a pin.

18. The locking/release device according to claim 17, wherein said locking element comprises a meshing ring that is kinematically connected to the rotation axis of at least one wheel, said meshing ring comprising a plurality of teeth that define said at least one abutment region, said at least one seat being provided between two adjacent teeth.

19. The locking/release device according to claim 18, wherein said locking element comprises a supporting bush that supports said supporting structure so that it can rotate about a castering axis.

20. The locking/release device according to claim 19, wherein said supporting bush comprises, at an edge that is arranged upward during use, said at least one abutment region and said at least one seat.

21. The locking/release device according to claim 16, wherein said trap spring comprises at least one spiral winding connected to a first thrust arm, which has a coupling element substantially at its free end, and to a second thrust arm, which has an abutment element substantially at its free end.

22. The locking/release device according to claim 21, wherein said trap spring comprises two spiral windings, said abutment element being adapted to connect the respective thrust arms.

23. The locking/release device according to claim 19 associated with a braking device or with a castering device.

24. The locking/release device according to claim 16, wherein said trap spring is associated with a braking device or with a castering device.
